(19) United States
(12) Patent Application Publication
(10) Pub. No.: US 2023/0238034 A1
(43) Pub. Date: Jul. 27, 2023

(54) AUTOMATIC VIDEO EDITING SYSTEM AND METHOD

(71) Applicant: Osense Technology Co., Ltd., Taipei City (TW)

(72) Inventors: FU-KUEI CHEN, Taipei City (TW); YOU-KWANG WANG, Taipei City (TW); HSIN-PIAO LIN, Taoyuan City (TW); HUNG-JUI LIU, Taipei City (TW)

(73) Assignee: Osense Technology Co., Ltd., Taipei City (TW)

(21) Appl. No.: 17/830,345

(22) Filed: Jun. 2, 2022

Related U.S. Application Data
(60) Provisional application No. 63/302,129, filed on Jan. 24, 2022.

(30) Foreign Application Priority Data
May 3, 2022 (TW) 111116725

(51) Int. Cl. G11B 27/031

(52) U.S. Cl. CPC G11B 27/031

(57) ABSTRACT

An automatic video editing system and method are provided. In the method, one or more images are obtained via one or more image capture devices. The images and a detection result of the images are transmitted according to the detection result of the images. A plurality of video materials are selected according to the images and the detection result thereof. The video materials are edited to generate a video clip collection. Accordingly, automatic broadcast may be achieved, thereby reducing manpower.

### CROSS-REFERENCE TO RELATED APPLICATION

This application claims the priority benefit of U.S. provisional application Ser. No. 63/302,129, filed on Jan. 24, 2022 and Taiwan application serial no. 111116725, filed on May 3, 2022. The entirety of each of the above-mentioned patent applications is hereby incorporated by reference herein and made a part of this specification.

### BACKGROUND OF THE INVENTION

### Field of the Invention

The invention relates to an image processing technique, and more particularly, to an automatic video editing system and method.

### Description of Related Art

The broadcast of some sports events needs a lot of manpower to shoot in different positions to avoid missing the exciting movements of the players. Auxiliary machines such as aerial cameras and robotic arms may also be needed for angles of view that may not be captured by people.

Taking golf as an example, there are more than 38,000 golf courses in 249 countries in the world, of which the United States has the most, Japan has the second most, and Canada has the third most. The broadcast of the tournaments attracts the attention of global audiences. Golf broadcasting needs a lot of manpower, and high-rigged cameras are set up for fixed-point shooting, aerial cameras are provided for shooting from the air, and shooting needs to follow the players. The wiring before the game, the shooting during the game, and the recovery of the venue after the game all need a lot of manpower and material resources. Therefore, it may be seen that a broadcast alone may be costly.

### SUMMARY OF THE INVENTION

Accordingly, an embodiment of the invention provides an automatic video editing system and method to provide automatic recording and editing, so as to achieve automatic broadcasting, thereby reducing manpower.

An automatic video editing system of an embodiment of the invention includes (but is not limited to) one or more stationary devices and a computing device. Each station device includes (but is not limited to) one or more image capture devices, communication transceivers, and processors. The image capture device is configured to obtain one or more images. The communication transceiver is configured to transmit or receive a signal. The processor is coupled to the image capture device and the communication transceiver. The processor is configured to transmit the images and a detection result via the communication transceiver according to the detection result of the images. The computing device is configured to select a plurality of video materials according to the images and the detection result thereof. The video materials are edited to generate a video clip collection.

An automatic video editing method of an embodiment of the invention includes (but is not limited to) the following steps: obtaining one or more images via one or more image capture devices. The images and a detection result of the images are transmitted according to the detection result of the images. A plurality of video materials are selected according to the images and the detection result thereof. The video materials are edited to generate a video clip collection.

Based on the above, according to the automatic video editing system and method of embodiment of the invention, stationary devices deployed in multiple places shoot images from different angles of view, and the images are transmitted to the computing device for automatic editing processing. In addition to enhancing the viewer's visual experience and sense of entertainment, field monitoring may also be conducted, thereby promoting digital transformation of various types of fields.

In order to make the aforementioned features and advantages of the disclosure more comprehensible, embodiments accompanied with figures are described in detail below.

### BRIEF DESCRIPTION OF THE DRAWINGS

FIG. 1 is a schematic diagram of an automatic video editing system according to an embodiment of the invention.

FIG. 2 is a block diagram of elements of a stationary device according to an embodiment of the invention.

FIG. 3 is a schematic perspective view and a partial enlarged view of a stationary device according to an embodiment of the invention.

FIG. 4 is a flowchart of an automatic video editing method according to an embodiment of the invention.

FIG. 5 is a flowchart of generating a highlight according to an embodiment of the invention.

FIG. 6 is a flowchart of detection according to an embodiment of the invention.

FIG. 7 is a flowchart of feature matching according to an embodiment of the invention.

FIG. 8 is a schematic diagram of image filtering according to an embodiment of the invention.

FIG. 9 is a flowchart of multi-streaming according to an embodiment of the invention.

FIG. 10 is a schematic diagram of device deployment according to an embodiment of the invention.

FIG. 11 is a schematic diagram of line of sight (LOS) propagation according to an embodiment of the invention.

### DESCRIPTION OF THE EMBODIMENTS

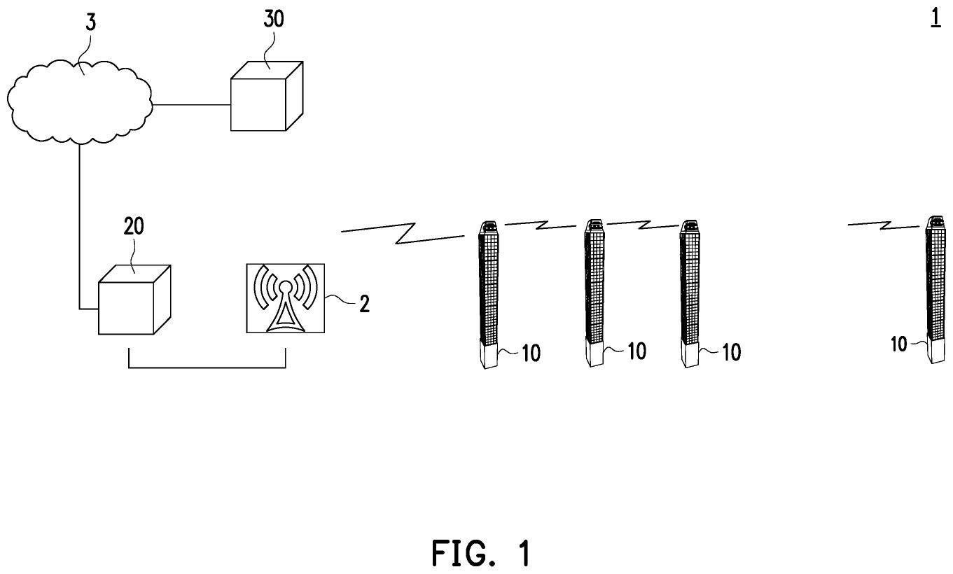

FIG. 1 is a schematic diagram of an automatic video editing system 1 according to an embodiment of the invention. Referring to FIG. 1, the automatic video editing system 1 includes (but is not limited to) one or more stationary devices 10, a computing device 20, and a cloud server 30.

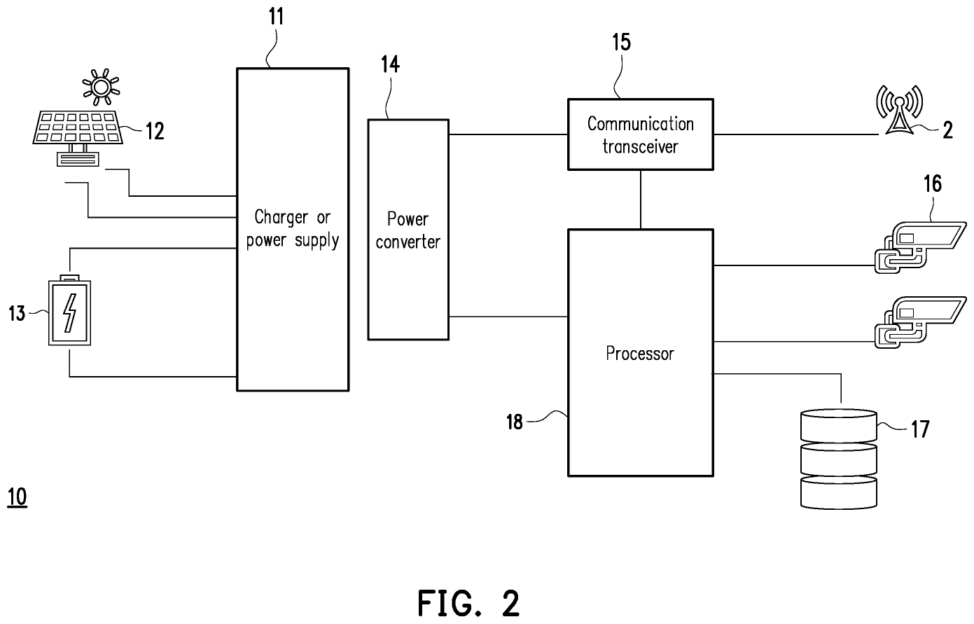

FIG. 2 is a block diagram of elements of a stationary device 10 according to an embodiment of the invention. Referring to FIG. 2, the stationary device 10 includes (but is not limited to) a charger or power supply 11, a solar panel 12, a battery 13, a power converter 14, a communication transceiver 15, one or more image capture devices 16, a storage 17, and a processor 18.

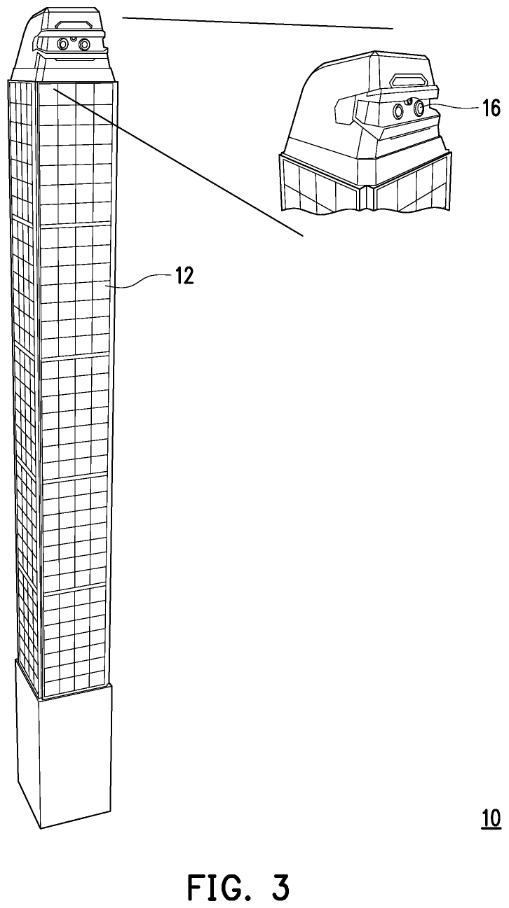

The charger or power supply 11 is configured to provide power for the electronic elements in the stationary device 10. In an embodiment, the charger or power supply 11 is connected to the solar panel 12 and/or the battery 13 to achieve autonomous power supply. FIG. 3 is a schematic perspective view and a partial enlarged view of the stationary device 10 according to an embodiment of the invention. Please refer to FIG. 3, assuming that the stationary device 10 is a column shape (but not limited to this shape), the solar panel 12 may be provided on four sides or the ground (but not limited to this arrangement position). In other embodiments, the charger or power supply 11 may also be connected to commercial power or other types of power sources.

The power converter 14 is (optionally) coupled to the charger or power supply 11 and configured to provide voltage, current, phase, or other power characteristic conversion.

The communication transceiver 15 is coupled to the power converter 14. The communication transceiver 15 may be a wireless network transceiver supporting one or more generations of Wi-Fi, 4th generation (4G), 5th generation (5G), or other generations of mobile networks. In an embodiment, the communication transceiver 15 further includes one or more circuits such as antennas, amplifiers, mixers, filters, and the like. The antenna of the communication transceiver 15 may be a directional antenna or an antenna array capable of generating a designated beam. In an embodiment, the communication transceiver 15 is configured to transmit or receive a signal.

The image capture device 16 may be a camera, a video camera, a monitor, a smart phone, or a circuit with an image capture function, and captures images within a specified field of view accordingly. In an embodiment, the stationary device 10 includes a plurality of image capture devices 16 configured to capture images of the same or different fields of view. Taking FIG. 3 as an example, the two image capture devices 16 form a binocular camera. In some embodiments, the image capture device 16 may capture 4K, 8K, or higher quality images.

The storage 17 may be any form of a fixed or movable random-access memory (RAM), read-only memory (ROM), flash memory, traditional hard-disk drive (HDD), solid-state drive (SSD), or similar devices. In an embodiment, the storage 17 is configured to store codes, software modules, configurations, data (e.g., images, detection results, etc.) or files, and the embodiments thereof will be described in detail later.

The processor 18 is coupled to the power converter 14, the communication transceiver 15, the image capture device 16, and the storage 17. The processor 18 may be a central processing unit (CPU), a graphics processing unit (GPU), or other programmable general-purpose or special-purpose microprocessors, digital signal processors (DSPs), programmable controllers, field-programmable gate arrays (FPGAs), application-specific integrated circuits (ASICs), neural network accelerators, or other similar devices or a combination of the above devices. In an embodiment, the processor 18 is configured to execute all or part of the operations of the stationary device 10, and may load and execute various codes, software modules, files, and data stored in the storage 17. In some embodiments, the functions of the processor 18 may be implemented by software or a chip.

The computing device 20 and the cloud server 30 may be a smart phone, a tablet computer, a server, a cloud host, or a computer host. The computing device 20 is connected to the stationary device 10 via a network 2. The computing device 20 is connected to the cloud server 30 via a core network 3. In some embodiments, some or all of the functions of the computing device 20 may be implemented on the cloud server 30.

Hereinafter, the method described in an embodiment of the present is described with various devices, elements, and modules in the smart system 1. Each of the processes of the present method may be adjusted according to embodiment conditions and is not limited thereto.

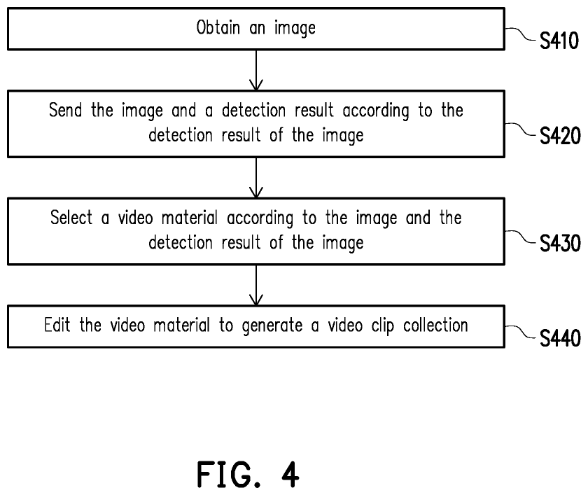

FIG. 4 is a flowchart of an automatic video editing method according to an embodiment of the invention. Referring to FIG. 4, the processors 18 of the one or more stationary devices 10 obtain one or more images via one or more image capture devices 16 (step S410). Specifically, a plurality of stationary devices 10 are deployed on a field (e.g., a ballpark, a racetrack, a stadium, or a riverside park). The stationary device 10 has one or more camera lenses. The shooting coverage is increased using different positions and/or different shooting angles, and images are captured accordingly.

In an embodiment, the processor 18 may stitch the images of the image capture devices 16 according to the angle of view of the image capture devices 16. For example, images of different shooting angles obtained by a single stationary device 10 at the same time point are stitched together. Therefore, using a fixed lens may save power for adjusting the angle of the lens. Even with solar or battery power, the power is still quite sufficient.

The processor 18 transmits the images and a detection result of the images according to the detection result of the images (step S420). Specifically, broadcasts of events often feature highlights to elevate viewers' interest. Some pictures captured by the stationary device 10 may not have a player, a car, or a state of motion. Huge number of images causes computational and network burden. Therefore, the stationary device 10 may select all or part of the images according to the detection result, and transmit only the selected images and the corresponding detection result.

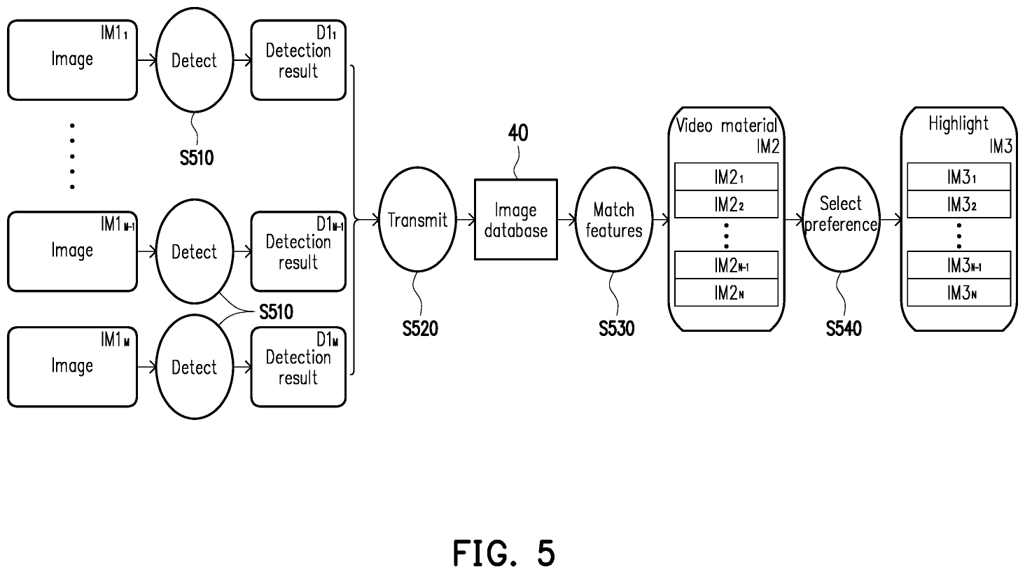

FIG. 5 is a flowchart of generating a highlight according to an embodiment of the invention. Referring to FIG. 5, for images IM1₁ to IM1_{M} captured by each of the stationary devices 10 (assuming M stations, where M is a positive integer), each of the processors 18 detects the position, feature, and/or state of one or more targets, respectively, in order to generate detection results D1₁ to D1_{M} of the images of each of the stationary devices (step S510).

The target may be a player, vehicle, animal, or any specified object. There are many algorithms for object detection in images. A feature may be an organ, element, area, or point on the target. A state may be a specific movement behavior, such as walking, swinging, hitting, or rolling over.

In an embodiment, the processor 18 may determine the detection result of the images via the detection model. The detection model is trained via machine learning algorithms, such as YOLO (You Only Look Once), SSD (Single Shot Detector), ResNet, CSPNet, BiFPN, and R-CNN. Object detection may identify the type or behavior of a target and marquee the position thereof.

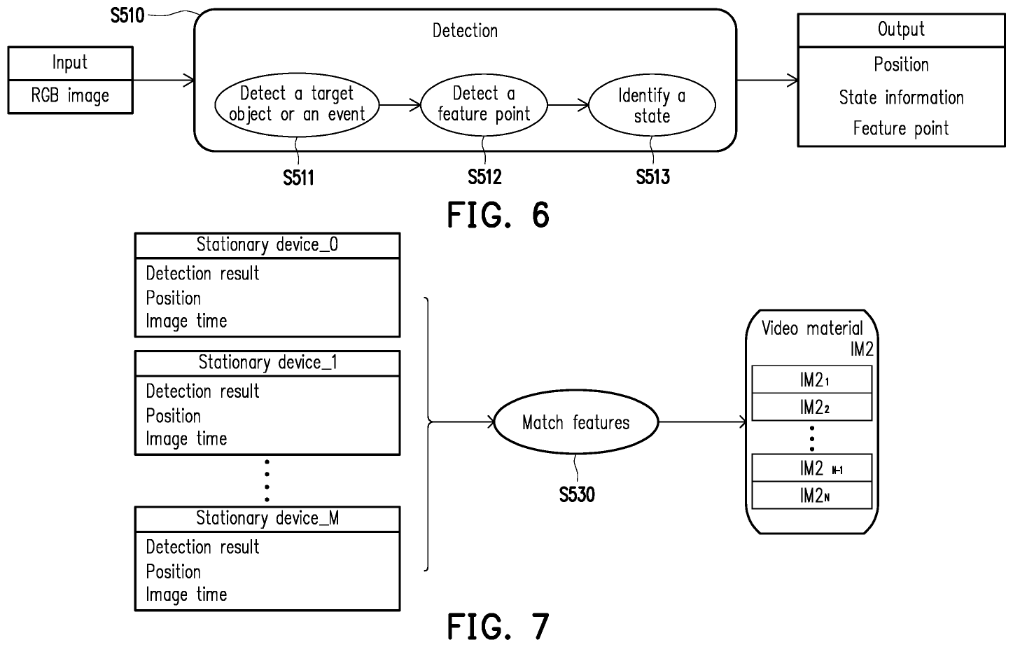

FIG. 6 is a flowchart of detection according to an embodiment of the invention. Referring to FIG. 6, the input to the detection model is image information (e.g., input feature maps for a specific color space (e.g., RGB (red-green-blue) or HSV (color-saturation-lightness)). The processor 18 may perform target object or event detection (step S511), feature point detection (step S512), and/or state identification (step S513) via the detection model, and output positions, states, and feature points accordingly.

Neural networks used in detection models may include a plurality of computing layers. In order to lighten the detection model, one or more computing layers in the detection model may be adjusted. In an embodiment, unnecessary operation layers or some of the channels thereof may be deleted, model depth and width may be reduced, and/or operation layers such as convolution layers may be adjusted (e.g., changing to depth-wise convolution layers, and matching with operation layers such as N*N convolution layers, activation layers, and batch normalization layers (N is a positive integer); and the connection method between operation layers may also be modified, e.g., techniques such as skip connection). The adjustment mechanism reduces the computational complexity of the model and maintains good accuracy. In an embodiment, for an adjusted lightweight model, the field data to be detected is added to re-optimize/train the model. According to the characteristics of the processor 18, the internal weight data of the detection model is modified, such as data quantization; the data stream of software and hardware is added to improve signal processing speed, such as the deep stream technique. The lightweight model may be applied to edge computing devices with worse computing capabilities, but the embodiments of the invention do not limit the computing capabilities of the devices applying the lightweight model.

In an embodiment, the processor 18 of the stationary device 10 may transmit a transmission request via the communication transceiver 15 according to the detection result of the images. The processor 18 may determine whether the detection result meets a transmission condition. The transmission condition may be the presence of a specific object and/or behavior thereof in the image. Examples include player A, player swing, player pass, and overtake. If the detection result meets the transmission condition, the stationary device 10 transmits the transmission request to the computing device 20 via the network 2. If the detection result does not meet the transmission condition, the stationary device 10 disables/does not transmit the transmission request to the computing device 20.

The computing device 20 schedules a plurality of transmission requests and issues transmission permissions accordingly. For example, the transmission requests are scheduled sequentially according to the shooting time of the images. Another example is to provide a priority order for a specific target or target event in the detection result. The computing device 20 sequentially issues the transmission permission to the corresponding stationary device 10 according to the scheduling result.

The processor 18 of the stationary device 10 may transmit the images and the detection result via the communication transceiver 15 according to the transmission permission. That is, the images are transmitted only after the transmission permission is obtained. The images are disabled/not transmitted until the transmission permission is obtained. Thereby, the bandwidth may be effectively utilized.

Referring to FIG. 4, the computing device 20 selects a plurality of video materials according to the images and the detection result of the images (step S430). Specifically, referring to FIG. 5, after the images IM1₁ to IM1_{M} and the detection results D1₁ to D1_{M} are transmitted to the computing device 20 (step S520), they may be temporarily stored in an image database 40 first. The computing device 20 may re-identify different targets (step S530) to classify images for the target, and use the classified images as video materials IM2 and IM2₁ to IM2_{N} of the target.

FIG. 7 is a flowchart of feature matching according to an embodiment of the invention. Referring to FIG. 7, the computing device 20 may determine the video materials IM2 and IM2₁ to IM2_{N} of the targets according to one or more targets in the images from different stationary devices 10 (e.g., stationary device_0, stationary device_1 . . . or stationary device_M), the positions of the stationary devices 10, and image time (step S530). For example, player A's entire game image or player B's entire game image is integrated in chronological order. As another example, when player B moves to the green, the computing device 20 selects the video material of the stationery device 10 close to the green.

In an embodiment, the computing device 20 may identify the target or the target event via the detection module or another detection model, and determine the classification result of the images accordingly. That is, the group to which the images belongs is determined according to the target or target event in the images. For example, player C is identified from consecutive images, and the images are classified into player C's group. Thereby, different targets in the field may be effectively distinguished. In other embodiments, the computing device 20 may directly use the detection result of the stationary device 10 (e.g., type identification of object detection) for classification.

In an embodiment, the computing device 20 may integrate the images of each target into a whole field image according to image time.

In some embodiments, the detection module used by the computing device 20 may also be reduced in weight, i.e., the adjustment of the operation layers and internal weight data in the neural network.

Referring to FIG. 4, the computing device 20 edits the video materials to generate one or more video clip collection (step S440). Specifically, the video materials are still only images for different targets. However, normal broadcasts may switch between different targets. Moreover, the embodiments of the invention are expected to automatically filter redundant information and output only highlights. In addition, editing may involve cropping, trimming, modifying, scaling, applying styles, smoothing, etc., of the images.

Referring to FIG. 5, in an embodiment, the computing device 20 may select a plurality of highlights IM3 and IM31 to IM3_{N} in the video materials IM2₁ to IM2_{N} according to one or more video content preferences (step S540). The video content preferences are, for example, the moment of hitting the ball, the process of hole-in, the moment of overtaking, and the process of pitching. The video content preferences may be changed due to application scenarios, which are not limited by the embodiments of the invention. The video clip collection is a collection of one or more highlights IM3 and IM3₁ to IM3_{N}, and the screen size or content of some or all of the highlights IM3 and IM3₁ to IM3_{N} may be adjusted as appropriate.

In an embodiment, the computing device 20 may input the video materials into an editing model to output a video clip collection. The editing model is trained by a machine learning algorithm (e.g., deep learning network, random forest, or support vector machine (SVM)). The machine learning algorithm may analyze training samples to obtain patterns therefrom, so as to predict unknown data via the patterns. The detection model is a machine learning model constructed after learning, and inferences are made based on the data to be evaluated. In an embodiment, the editing model uses test images and known image content preferences thereof as training samples. In this way, the editing model may select highlights from the video materials and concatenate them into a video clip collection accordingly.

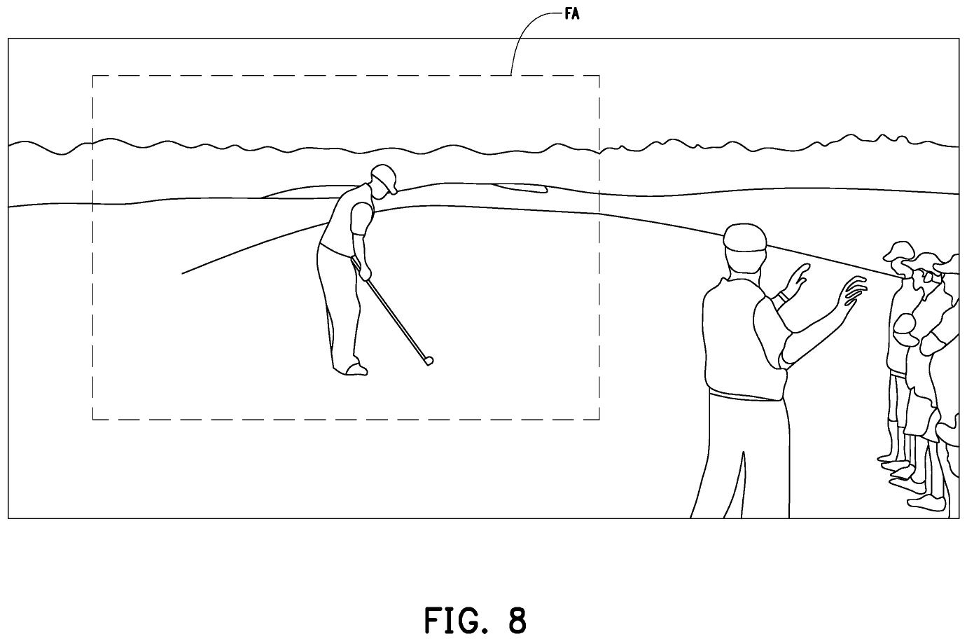

In an embodiment, the computing device 20 may filter out redundant content from each highlight. The redundant content may be other objects, scenes, patterns, or words other than the target. The filtering method may be directly cropping or changing to the background color. For example, FIG. 8 is a schematic diagram of image filtering according to an embodiment of the invention. Referring to FIG. 8, the computing device 20 frames the position of the target from the images, and uses the frame selection range as a focus range FA. The computing device 20 may trim images outside the focus range FA.

In an embodiment, the focus range FA may also move with the target. For example, the position of the focus range FA is updated via an object tracking technique. There are also many algorithms for object tracking. Examples include optical flow, sorting method SORT (Simple Online and Realtime Tracking), or depth sorting method (Deep SORT), and joint detection and embedding (JDE).

In an embodiment, the computing device 20 may provide a close-up of one or more targets in the highlights. For example, the computing device 20 may zoom in or zoom out the target in the images based on the proportion of the target in the images (i.e., image scaling), so that the target or a portion thereof is made to occupy approximately a certain proportion (e.g., 70, 60, or 50 percent) of the images. In this way, a close-up effect may be achieved.

In some embodiments, the editing model is trained on image filtering and/or target close-ups. For example, the editing model uses test images and known filtering results and/or close-up patterns thereof as training samples.

In an embodiment, during the training of the editing model, the computing device 20 may establish a relationship between the position of one or more targets in the images and one or more camera movement effects. For example, if the target moves left and right, a left and right translation camera movement is provided. If the target moves back and forth, a zoom in or zoom out camera movement is provided. In this way, by inputting the video materials, the corresponding camera movement effect may be output.

In an embodiment, during the training of the editing model, the computing device 20 may establish a relationship between one or more targets and one or more scripts. In this way, by inputting the video materials, a video clip collection conforming to the script may be output. For example, on the third hole, during player D's swing, the front, side, and back images of player D are taken in sequence. It should be noted that scripts may vary depending on the application context. For example, the context of a racing car may be a switch between the driver's angle of view, the track-front angle of view, and the track-side angle of view. In addition, scripts may be recorded in texts or storyboards. In this way, the highlights may be formed into a video clip collection.

In an embodiment, the video clip collection may be uploaded to the cloud server 30 via the core network 3 for viewing or downloading by the user. In addition, if the computing and/or network speed allows, real-time broadcast function may also be achieved.

In some embodiments, the cloud server 30 may further analyze the game, and even provide additional applications such as coaching consultation or field monitoring.

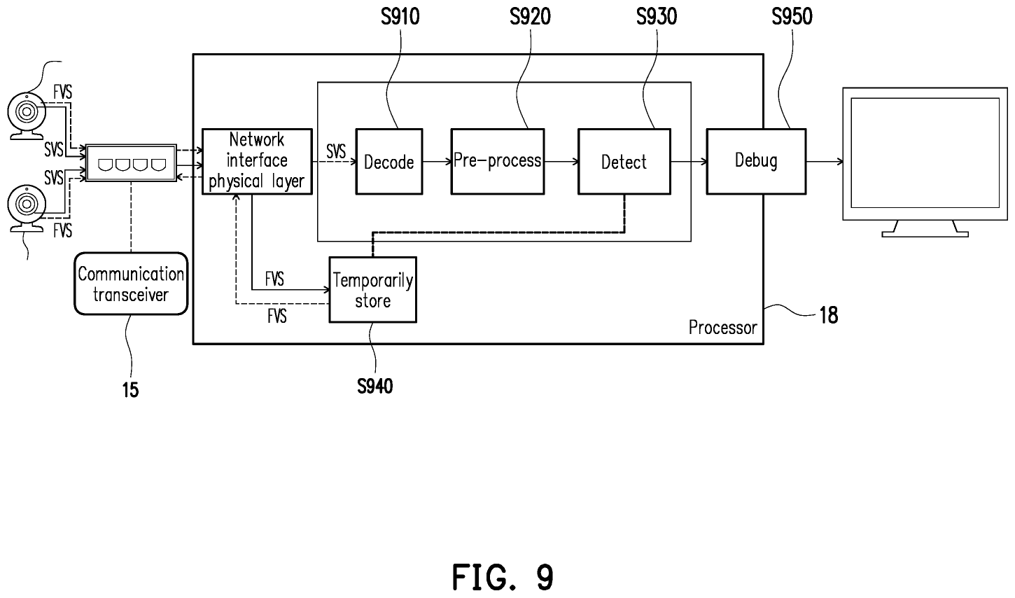

In addition to the transmission schedule, an embodiment of the invention also provides distributed image capture and temporary storage. FIG. 9 is a flowchart of multi-streaming according to an embodiment of the invention. Referring to FIG. 9, in an embodiment, one or more image capture devices 16 perform image capture and generate a first image code stream FVS and a second image code stream SVS. The resolution of the first image code stream FVS is higher than that of the second image code stream SVS. For example, the resolution of the first image code stream FVS is 4K and 8 million pixels, and the second image code stream SVS is 720P and 2 million pixels. The first image code stream FVS and the second image code stream SVS are transmitted to the processor 18 via the physical layer of the network interface.

The processor 18 may only identify one or more targets or one or more target events in the second image stream SVS to generate an image detection result. Specifically, the processor 18 may decode the second image stream SVS (step S910). For example, if the second image code stream SVS is encoded by H.265, the content of one or more image frames may be obtained after decoding the second image code stream SVS. The processor 18 may pre-process the image frame (step S920). Examples include contrast enhancement, de-noising, and smoothing. The processor 18 may detect the image frame (step S930). That is, step S420 is for the detection of the position, feature, and/or state of the target. In an embodiment, the processor 18 may also set a region of interest in the images, and only detect targets within the region of interest. In an embodiment, if a network interface is used for transmission, the processor 18 may set the network positions of the image capture device 16 and the processor 18.

The processor 18 may store the first image code stream FVS according to the detection result of the images. If a target is detected, the processor 18 temporarily stores the first image stream FVS corresponding to the image frame in the storage 17 or other storage devices (e.g., flash drive, SD card, or database) (step S940). If a target is not detected, the processor 18 deletes, discards, or ignores the first image code stream FVS corresponding to the image frame. In addition, if necessary, the detection model may be debugged according to the detection result (step S950).

Then, the processor 18 may transmit the transmission request via the communication transceiver 15. In response to obtaining the transmission permission, the processor 18 transmits the temporarily stored first image code stream FVS via the communication transceiver 15. The computing device 20 may select subsequent video materials and generate a video clip collection for the first image stream FVS.

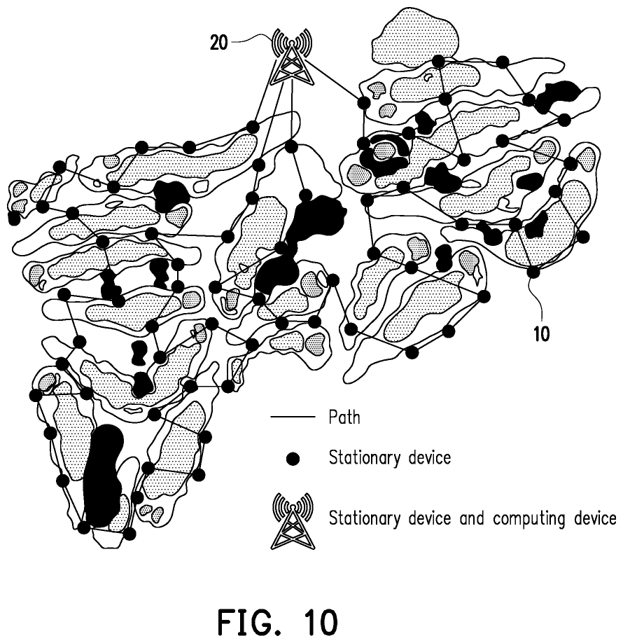

In regards to resource allocation for transmission, FIG. 10 is a schematic diagram of device deployment according to an embodiment of the invention. Referring to FIG. 10, the computing device 20 may allocate radio resources according to the transmission request sent by each of the stationary devices 10 and determine which of the stationary devices 10 may obtain the transmission permission. As described above, the stationary device 10 needs to obtain the transmission permission before it may start to transmit images.

It is also worth noting that, as shown in FIG. 10, the stationary devices 10 may perform point-to-point transmission, i.e., the transmission between the stationary devices 10. Some of the stationary devices 10 are used as relay stations to transmit images from a distance to the computing device 20 in sequence.

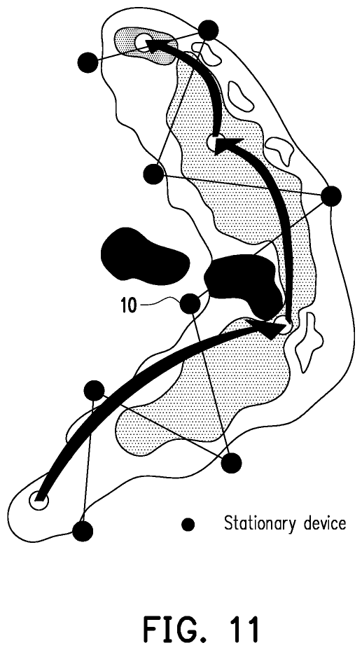

FIG. 11 is a schematic diagram of line of sight (LOS) propagation according to an embodiment of the invention. Please refer to FIG. 11, the communication transceiver 15 of the stationary device 10 further includes a directional antenna. The directional antenna of the stationary device 10 establishes line of sight (LOS) propagation with the directional antenna of another stationary device 10. Obstacles affect transmission loss, and are not conducive to transmission. For the radiation direction of the antenna, it may be directed to an area with no obstacles or few obstacles, and another stationary device 10 is deployed in this area. As shown in FIG. 11, the line of sight between the stationary devices 10 may form a Z-shaped or zigzag connection, thereby improving transmission quality.

It is also worth noting that the use of mobile networks for image transmission may incur high tariffs. Although the tariff of optical fiber network may be lower in comparison, the wiring cost of wired transmission may not be ignored. In an embodiment of the invention, a part of Wi-Fi is combined with a directional antenna for point-to-point transmission, and then sent to an external network via a mobile network. In the public (Industrial Scientific Medical, ISM) frequency band, using an open field as a natural wireless transmission channel may improve the wireless transmission effect and cut down costs.

In an embodiment, the communication transceiver 15 may change one or more communication parameters (e.g., gain, phase, encoding, or modulation) according to channel changes to maintain transmission quality. For example, signal intensity is maintained above a certain threshold.

Based on the above, in the automatic video editing system and method of an embodiment of the invention, stationary devices that automatically detect the target and are self-powered, schedule the transmission of images, automatically select video materials, and generate a video clip collection related to highlights are deployed. Additionally, line-of-sight (LOS) propagation is provided for wireless transmission. Thereby, manpower may be eliminated, and user viewing experience may be improved.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An automatic video editing system, comprising:
at least one stationary device, wherein each of the stationary devices comprises:
at least one image capture device configured to obtain a plurality of images;
a communication transceiver configured to transmit or receive a signal; and
a processor coupled to the at least one image capture device and the communication transceiver and configured to transmit the images and a detection result via the communication transceiver according to the detection result of the images; and
a computing device configured to:
select a plurality of video materials according to the images and the detection result of the images; and
edit the video materials to generate a video clip collection.

2. The automatic video editing system of claim 1, wherein one of the stationary devices comprises a plurality of the image capture device, and the processor is further configured to:
stitch images of the image capture devices according to an angle of view of the image capture devices.

3. The automatic video editing system of claim 1, wherein one of the stationary devices comprises a charger or a power supply, and the charger or the power supply is connected to a solar panel or a battery.

4. The automatic video editing system of claim 1, wherein the computing device is further configured to:
input the video materials into an editing model to output the video clip collection, wherein the editing model is trained by a machine learning algorithm.

5. The automatic video editing system of claim 4, wherein the computing device is further configured to:
in a training of the editing model,
establish a relationship between a position of at least one target in one of the images and at least one motion effect; or
establish a relationship between the at least one target and at least one script.

6. The automatic video editing system of claim 1, comprising a plurality of stationary devices, wherein the detection result of the images comprises at least one of a position, a feature, and a state of at least one target, and the computing device is further configured to:
determine a video material of the at least one target according to the at least one target in the images, positions of the stationary devices, and an image time.

7. The automatic video editing system of claim 6, wherein the processor is further configured to:
determine the detection result of the images via a detection model, wherein the detection model is trained via a machine learning algorithm; and
adjust at least one operational layer in the detection model.

8. The automatic video editing system of claim 1, wherein the computing device is further configured to:
select a plurality of highlights in the video materials according to at least one image content preference; and
filter out a redundant content from each of the highlights or provide a close-up of at least one target in one of the highlights.

9. The automatic video editing system of claim 1, wherein the processor of the at least one stationary device transmits a transmission request via the communication transceiver according to the detection result of the images, the computing device schedules a plurality of the transmission request and issues a transmission permission accordingly, and the processor transmits the images via the communication transceiver according to the transmission permission.

10. The automatic video editing system of claim 9, wherein the at least one image capture device generates a first image code stream and a second image code stream, a resolution of the first image code stream is higher than that of the second image code stream, the processor identifies at least one target or at least one target event in the second image stream to generate the detection result of the images, the processor stores the first image code stream according to the detection result of the images, and in response to obtaining the transmission permission, the processor transmits the first image code stream via the communication transceiver.

11. The automatic video editing system of claim 1, comprising a plurality of stationary devices, wherein the communication transceiver comprises a directional antenna, and the directional antenna of one of the stationary devices establishes a line of sight (LOS) propagation with the directional antenna of another of the stationary devices.

12. The automatic video editing system of claim 1, wherein the communication transceiver changes at least one communication parameter according to a channel change to maintain a transmission quality.

13. An automatic video editing method, comprising:
obtaining a plurality of images via at least one image capture device;
transmitting the images and a detection result according to the detection result of the images;
select a plurality of video materials according to the images and the detection result of the images; and
edit the video materials to generate a video clip collection.
